(19) United States
(12) Patent Application Publication
(10) Pub. No.: US 2025/0373519 A1
(43) Pub. Date: Dec. 4, 2025

(54) ELECTRONIC DEVICE AND METHOD FOR GENERATING VIRTUALIZED NETWORK FUNCTION IN NETWORK FUNCTION VIRTUALIZATION ENVIRONMENT

(71) Applicant: Samsung Electronics Co., Ltd., Suwon-si (KR)

(72) Inventor: Hyunyoung NAM, Suwon-si (KR)

(21) Appl. No.: 19/295,054

(22) Filed: Aug. 8, 2025

Related U.S. Application Data
(63) Continuation of application No. PCT/KR2024/000481, filed on Jan. 10, 2024.

(30) Foreign Application Priority Data
Feb. 8, 2023 (KR) 10-2023-0017074

(51) Int. Cl. H04L 41/40; H04W 8/20; H04W 12/06; H04W 60/00; H04W 76/10

(52) U.S. Cl. CPC H04L 41/40; H04W 8/20; H04W 12/06; H04W 60/00; H04W 76/10

(57) ABSTRACT

A method performed by an electronic device for a virtualized network function manager (VNFM) is provided. The method includes transmitting authentication information to an element management system (EMS) generated by another VNFM distinct from the VNFM, wherein the authentication information is used to register the VNFM in a subscription list, receiving, from the EMS, a subscription request message, including the authentication information, performing, based on the registration for the EMS, a process for the instantiation of a network element (NE), based on the process for the instantiation of the NE, transmitting a lifecycle management change (LCM) notification message to the EMS, and based on the LCM notification message, connecting the NE to the EMS.

### CROSS-REFERENCE TO RELATED APPLICATION(S)

This application is a continuation application, claiming priority under 35 U.S.C. § 365 (c), of an International application No. PCT/KR2024/000481, filed on Jan. 10, 2024, which is based on and claims the benefit of a Korean patent application number 10-2023-0017074, filed on Feb. 8, 2023, in the Korean Intellectual Property Office, the disclosure of which is incorporated by reference herein in its entirety.

### BACKGROUND

### 1. Field

The disclosure relates to a wireless communication system. More particularly, the disclosure relates to an electronic device and a method for generating a virtualized network function in a network function virtualization environment.

### 2. Description of Related Art

Network function virtualization (NFV) technology is a technology for an operator to manage a network more quickly and flexibly by implementing network devices, which are implemented in hardware, to be installed or removed in a form of software on a server.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for generating a virtualized network function in a network function virtualization environment.

Additional aspects will be set forth in part in the description which follows and, in part, will be apparent from the description, or may be learned by practice of the presented embodiments.

In accordance with an aspect of the disclosure, a method performed by an electronic device for a virtualised network function manager (or a virtualized network function manager) (VNFM) is provided. The method includes transmitting authentication information to an element management system (EMS) instantiated by another VNFM distinct from the VNFM, wherein the authentication information is used for a registration to a subscription list of the VNFM, receiving, from the EMS, a subscription request message including the authentication information, performing, based on the registration for the EMS, a process for an instantiation of a network element (NE, based on the process for the instantiation of the NE, transmitting, to the EMS, a lifecycle management change (LCM) notification message, and based on the LCM notification message, connecting the NE to the EMS.

In accordance with another aspect of the disclosure, a method performed by an electronic device for an element management system (EMS) is provided. The method includes receiving authentication information from a second virtualised network function manager (VNFM) distinct from a first VNFM, wherein the authentication information is used for a registration to a subscription list of the second VNFM, based on the authentication information, transmitting, to the second VNFM, a subscription request message including the authentication information, based on a process for an instantiation of a network element (NE), receiving, from the second VNFM a lifecycle management change (LCM) notification message, and based on the LCM notification message, establishing a connection to the NE.

In accordance with another aspect of the disclosure, an electronic device for a virtualised network function manager (or a virtualized network function manager) (VNFM) is provided. The electronic device includes memory, comprising one or more storage media, storing instructions, a transceiver, and one or more processors communicatively coupled with the memory and the transceiver, wherein the instructions, when executed by the one or more processors individually or collectively, cause the electronic device to transmit authentication information to an element management system (EMS) instantiated by another VNFM distinct from the VNFM, wherein the authentication information is used for a registration to a subscription list of the VNFM, receive, from the EMS, a subscription request message including the authentication information, perform, based on the registration for the EMS, a process for an instantiation of a network element (NE, based on the process for the instantiation of the NE, transmit, to the EMS, a lifecycle management change (LCM) notification message, and based on the LCM notification message, connect the NE to the EMS.

In accordance with another aspect of the disclosure, an electronic device is provided. The electronic device includes memory, including one or more storage media, storing instructions, a transceiver, and one or more processors communicatively coupled with the memory and the transceiver, wherein the instructions, when executed by the one or more processors individually or collectively, cause the electronic device to provide, through a virtualised network function manager (VNFM), authentication information to an element management system (EMS) instantiated by another VNFM distinct from the VNFM, wherein the authentication information is used for a registration to a subscription list of the VNFM, obtain the authentication information through the EMS, based on the authentication information, provide, to the VNFM, a subscription request message including the authentication information through the EMS, obtain, from the EMS, the subscription request message including the authentication information, through the VNFM, based on the registration for the EMS, perform a process for an instantiation of a network element (NE), through the VNFM, based on the process for the instantiation of the NE, provide, to the EMS, a lifecycle management change (LCM) notification message, through the VNFM, obtain, from the VNFM, the LCM notification message through the EMS, and based on the LCM notification message, establish a connection between the EMS and the NE.

In accordance with another aspect of the present disclosure, one or more non-transitory computer-readable storage media storing one or more computer programs including computer-executable instructions that, when executed by one or more processors of an electronic device individually or collectively, cause the electronic device to perform operations are provided. The operations include transmitting authentication information to an element management system (EMS) instantiated by another VNFM distinct from the VNFM, wherein the authentication information is used for a registration to a subscription list of the VNFM, receiving, from the EMS, a subscription request message including the authentication information, performing, based on the registration for the EMS, a process for an instantiation of a network element (NE), based on the process for the instantiation of the NE, transmitting, to the EMS, a lifecycle management change (LCM) notification message, and based on the LCM notification message, connecting the NE to the EMS.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates examples of a network service according to an embodiment of the disclosure;

FIG. 1B is a diagram for explaining a virtualised network function (VNF) according to an embodiment of the disclosure;

FIG. 2A illustrates an example of a network function virtualization (NFV)-management and orchestration (MANO) architecture framework of a 3rd generation partnership project (3GPP) according to embodiment of the disclosure;

FIG. 2B illustrates an example of an NFV-MANO architecture framework of a European Telecommunications Standards Institute (ETSI) according to an embodiment of the disclosure;

FIG. 3 illustrates an example of an operation of a consumer and VNFM for ‘LCM Change notification’ according to an embodiment of the disclosure;

FIG. 4 illustrates an example of an operation of a consumer and VNFM for subscription management according to an embodiment of the disclosure;

FIG. 5 illustrates an example of an operation of EMS, VNFM, and NE according to an instantiation of the NE according to an embodiment of the disclosure;

FIG. 6 is a flowchart with respect to an operation of an electronic device for VNFM according to an embodiment of the disclosure;

FIG. 7 is a flowchart with respect to an operation of an electronic device for EMS according to an embodiment of the disclosure; and

FIG. 8 is a flowchart with respect to an operation of an electronic device for VNFM and EMS according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

A term referring to a signal (e.g., a signal, information, a message, or signaling), a term referring to a resource (e.g., a symbol, a slot, a subframe, a radio frame, a subcarrier, a resource element (RE), a resource block (RB), a bandwidth part (BWP), or an occasion), a term referring to a calculation state (e.g., a step, an operation, or a procedure), a term referring to data (e.g., a packet, a user stream, information, a bit, a symbol, or a codeword), a term referring to a channel, a term referring to a network entity, a term referring to a component of a device, and the like, that are used in the following description, are exemplified for convenience of explanation. Therefore, the disclosure is not limited to terms to be described below, and another term having an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {′C′, ‘D’, and ‘C’ and ‘D’}.

The disclosure describes various embodiments using terms used in some communication standards (e.g., a 3rd generation partnership project (3GPP), a European telecommunications standards institute (ESTI)), but this is only an example for explanation. Various embodiments of the disclosure may be easily modified and applied in another communication system.

A management and orchestration (MANO) system for management of a virtualized base station is defined in an international fifth generation (5G) communication standard, including the 3rd generation partnership project (3GPP) standard and the European telecommunications standards institute (ESTI). Hereinafter, in the disclosure, a technical feature for managing a network element (NE) in the management and orchestration (MANO) system for managing the virtualized base station may be described.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

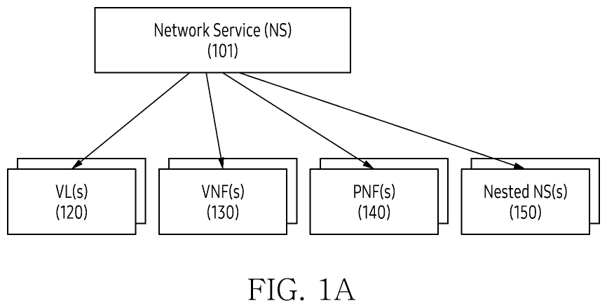

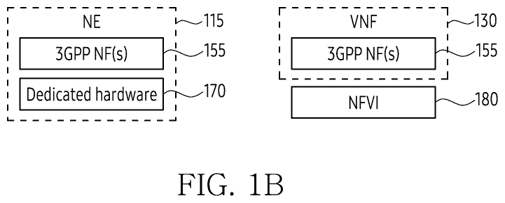

FIG. 1A illustrates examples of a network service according to an embodiment of the disclosure. The network service, which is a component of NFV-MANO, may be an NFV network service.

Referring to FIG. 1A, the NFV network service is a composition of a network function (NF) arranged in a set of functions and/or NSs.

As illustrated in FIG. 1A, a network service 101 may include one or more possible constituent objects. The network service 101 may be used by NFV Management and Orchestration (NFV-MANO) functions to deploy an NS instance. A configuration of the network service 101 may include at least one of one or more virtual links (VLs) 120, one or more virtual network functions (VNFs) 130, one or more physical network functions (PNFs), or one or more nested network services (NSs). In terms of the management and orchestration, the NFV-MANO may manage a lifecycle of NS by using an NS descriptor (NSD).

The VL 120 may abstract two or more connection types and attributes of VNF components (VNFFC), the VNF 130, the PNF 140, and the nested NS 150. In terms of the management and orchestration, the NFV-MANO may use a VL descriptor (VNF VLD) and NS VLD.

The VNF 130 indicates an NF implementation that may be deployed in a virtualized infrastructure. The VNF 130 is irrelevant to functionality of the NF indicated by the VNF 130. In terms of the NFV-MANO, deployment and operational behavior requirements of the VNF 130 may be stored by an on-boarded VNF descriptor (VNFD) as a portion of a file archive known as a VNF package. The VNFD may describe an attribute and requirements needed to realize an instance of the VNF 130, and capture the requirements for managing a corresponding lifecycle in an abstract manner.

The PNF 140 indicates a software workload closely connected to the deployed hardware. In a case that the PNF is a portion of the NS, the NFV-MANO may manage PNF connectivity with another component of this NS instance by using the PNF descriptor (PNFD).

FIG. 1B is a diagram for explaining a virtualised network function (VNF) according to an embodiment of the disclosure.

The VNF exemplifies the VNF 130 of FIG. 1A. A 3GPP system may provide various technologies for virtualization. A network and service provider may use different information in a number of ways that may vary from network to network and from time to time. In terms of 3GPP, the VNF may include a network function (NF) of a network element (NE). A relationship between an NE instance and a VNF instance may vary according to a relationship between functions included in the NF of the NE and the VNF.

Referring to FIG. 1B, a component of a network element (NE) 115 may include an NF 135 of the 3GPP. Herein, the NF 135 refers to a processing function in a network having a defined function operation and a defined interface. The component of the NE 115 may include dedicated hardware 170. The NF 135 of the NE 115 may be executed on a resource of the dedicated hardware 170.

A component of the VNF 130 may include an NF 155 of the 3GPP. The NF 155 refers to a processing function in a network having a defined function operation and a defined interface. The VNF 130 refers to an NF executed in an NFV infrastructure (NFVI) 180. The VNF 130 may include a) functionality of NF, elements for supporting an NF function, c) elements for allowing the VNF 130 to be executed in the NFVI 180. a), and b) may be an application part of the VNF, and c) may be a virtualization-specific part of the VNF 130. Examples of the elements for supporting the NF function may include a library, a database, and a protocol stack. According to an embodiment, for the same type of the NF, a function of the VNF, that is, the NF 155 may be the same as the NF 135 of the NE 115.

The application part of the VNF 130 may be managed by an element manager (EM). For example, in a case that the EM is not realized by the VNF 130, the EM may manage the application part of the VNF 130 through the defined interface. As another example, a function of the EM and the VNF 130 may be implemented in one VNF. The virtualization-specific part of the VNF 130 may be managed by a VNF manager (VNFM).

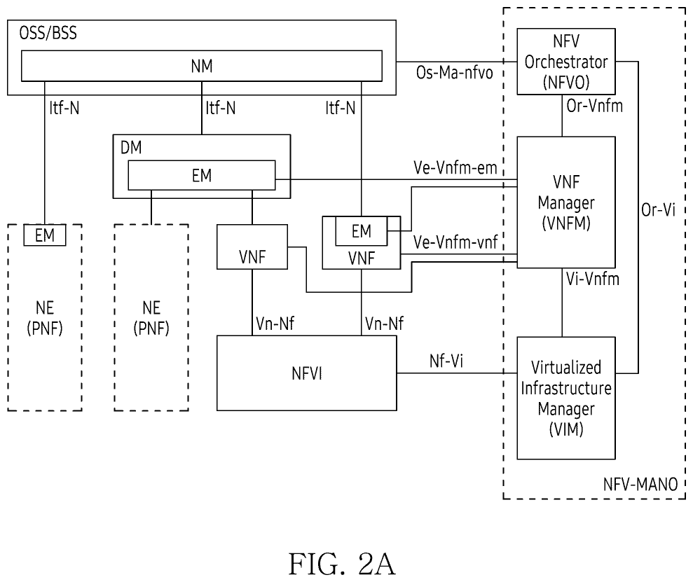

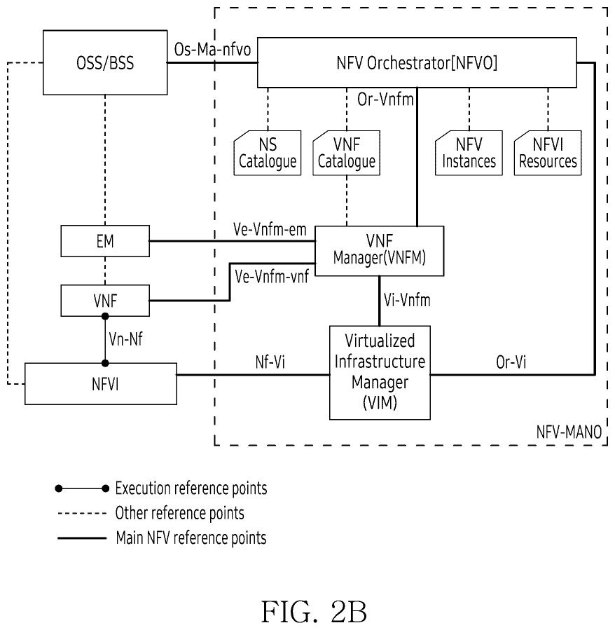

The international 5G communication standard, such as the 3GPP and the ETSI, define the Management and Orchestration (MANO) system for the management of the virtualized base station. Hereinafter, an architecture of an NFV environment defined in each standard is described with reference to FIGS. 2A and 2B.

FIG. 2A illustrates an example of a network function virtualization (NFV)-management and orchestration (MANO) architecture framework of a 3rd generation partnership project (3GPP) according to an embodiment of the disclosure.

A description with respect to EM, NE, PNF, VNF, or NFVI illustrated in FIG. 2A may be referred to in FIGS. 1A and 1B.

FIG. 2B illustrates an example of an NFV-MANO architecture framework of a European Telecommunications Standards Institute (ETSI) according to an embodiment of the disclosure.

A description with respect to EM, NE, PNF, VNF, or NFVI illustrated in FIG. 2B may be referred to in FIGS. 1A and 1B.

Referring to FIGS. 2A and 2B, the 3GPP and the ETSI define the same network elements and the same reference points for the NFV-MANO architecture framework. The same name (e.g., VNFM, VIM, or NFVO) and the same reference point (e.g., Ve-VNFM-em, or Ve-Vnfm-vnf) means the same interface.

Physical mobile network management may be primarily dependent on interface Itf-N. With introduction of NFV, mobile network management may designate virtualized network function management. The mobile network management may include interaction with the NFV-MANO performed through defined reference points as well as one interface Itf-N. A mobile network may be configured with a physical network element and a virtual network element. An application-related aspect of VNFs and PNFs corresponding to a physical NE may be managed in a 3GPP management system.

In order to expand management functions for the virtualized network and the VNF, a network manager (NM), a network manager (NM), and an element manager (EM) may be defined in the 3GPP management system. The NM is one of roles of an operating support system (OSS)/BSS and is a consumer of a reference point Os-Ma-nfvo. The NM may perform one of the roles of the OSS/BSS in a 3GPP specification. DM may provide an element management function and a domain management function for a subnetwork. Linked domain administrators may provide a multi-vendor and multi-technical network management function. The EM may provide an end-user functional package for managing a set of closely related types of network elements. The EM may support an element management function and a subnetwork management function. In a case that the EM supports an extension function, the EM may manage at least one of the PNF and the VNF.

The NFV-MANO may include an NFV orchestrator (NFVO), a VNF manager (VNFM), a virtualised infrastructure manager (VIM). The NFVO is a functional block to ensure optimized allocation of a necessary resource and connection by managing a lifecycle of a network service and coordinating management of an NS lifecycle, a VNF lifecycle (supported by the VNFM), and an NFVI resource (supported by the VIM). The VNFM is a functional block responsible for lifecycle management of the VNF. The VIM is a functional block that generally controls and manages NFVI computing, a storage, and a network resource in an infrastructure domain (e.g., the NFVI) of one operator.

According to an embodiment, the Os-Ma-nfvo may be used for NS lifecycle management, NS performance management, NS failure management, NSD management, and VNF package management instantiated by the NFVO. According to an embodiment, the Ve-VNFM-em and the Ve-Vnfm-vnf may be mainly used for VNF lifecycle management, VNF and VR failure information transmission, or performance measurement information and virtualization configuration.

The MANO of the VNF may include fault management, configuration management, accounting management, performance management, and security management (FCAPS). In addition, due to separation of the network function in the physical infrastructure used, a new set of management functions focusing on an instantiation and lifecycle management of a virtualized resource required for the VNF may be obtained. This set of management functions may be referred to as VNF management. The VNF management includes the following tasks and may be responsible for the lifecycle management of the VNF.
1) Instantiation of VNF (instantiate the VNF by using a VNF on-boarding artifact).
2) VNF scale (increase or decrease of VNF capacity).
3) Update and/or upgrade VNF (supports a configuration change in VNF software and/or various complexities).
4) Termination of VNF (release a VNF-related NFVI resource and return it to an NFVI resource pool).

The NFV-MANO is configured with the NFVO, the VNFM, and the VIM, and although roles of each component are slightly different, all components have a common goal of life cycle management of the VNF. The NFV-MANO may be responsible for overall VNF management until the VNF is instantiated and deleted. As described above, the lifecycle management of the VNF may include various functions. For example, the lifecycle management of the VNF may include a function to instantiate the VNF (i.e., instantiation of the VNF) and delete (i.e., termination of the VMF). Additionally, the lifecycle management of the VNF may include a scale-out/in function that increases or decreases the number of VNF components (VNFFCs) in the VNF, and a function to upgrade software of the VNF. For example, operations for the lifecycle management are defined in an ETSI GR NFV-MAN standard as follows.

TABLE 1

| Operations | Description | Notes |
|---|---|---|
| Instantiate | This operation allows | |
| VNF | creating a VNF instance. | |
| Query VNF | This operation allows | Attributes returned can include for |
| | retrieving VNF instance | example number and location of |
| | state and attributes. | VMs allocated to the VNF instance. |
| Scale VNF | This s operation allows | |
| | scaling (out/in, up/down) a | |
| | VNF instance. | |
| Check VNF | This operation allows | No VNF instance is created as a |
| instantiation | verifying if the VNF | result of the operation. |
| feasibility | instantiation is possible. | |
| Heal VNF | This operation is used to | This assumes operational behavior |
| | request appropriate | for healing actions by VNFM has |
| | correction actions in | been described in the VNFD. An |
| | reaction to a failure. | example could be switching between |
| | | active and standby mode. |
| Update VNF | This operation allows | The software update implies no |
| software | applying a minor/limited | structural changes (e.g. in |
| | software update (e.g. patch) | configuration, topology, behavior, |
| | to a VNF instance. | redundancy model). |
| | | The goal is to not require |
| | | termination/re-instantiation, or at |
| | | least not for the entire VNF. |
| | | This operation is only required if the |
| | | software update procedure requires a |
| | | change in the VNF infrastructure e.g. |
| | | changing an image. Software updates |
| | | that can be performed using solely |
| | | pre-existing functional blocks (e.g. |
| | | EM) could not invoke this operation. |
| Modify | This operation allows | This could be expected to be |
| VNF | making structural changes | designed as a transaction, rather than |
| | (e.g. configuration, | an atomic operation. |
| | topology, | Depending on the “modification |
| | behavior, redundancy | plan”, it could involve multiple |
| | model) to a VNF instance. | catalogue Management and VNF |
| | | lifecycle management atomic |
| | | operations, and could involve |
| | | multiple VNFM managers. It is |
| | | possible that this transaction cannot |
| | | be exposed as an operation by the |
| | | VNFM, and only offered as an |
| | | extension when exposed by the |
| | | NFVO. |
| Upgrade | This operation allows | This could be expected to be |
| VNF | deploying a new software | designed as a transaction, rather than |
| software | release to a VNF instance. | an atomic operation. |
| | | Depending on the “software upgrade |
| | | plan”, it could involve |
| | | multiple catalogue Management and |
| | | VNF lifecycle management atomic |
| | | operations, and could involve |
| | | multiple VNFM managers. It is |
| | | possible that this transaction cannot |
| | | be exposed as an operation by the |
| | | VNFM, and only offered as an |
| | | extension when exposed by the |
| | | NFVO. This operation is only |
| | | required if the software upgrade |
| | | procedure requires a change in the |
| | | VNF infrastructure e.g. changing an |
| | | image. Software upgrades that can be |
| | | performed using solely pre-existing |
| | | functional blocks |
| | | (e.g. EM) could not invoke this |
| | | operation. |
| Terminate | This operation allows | |
| VNF | terminating gracefully or | |
| | forcefully a previously | |
| | created VNF instance. | |

The VNF (or the EMS, the NE) instantiated through a MANO system may receive a ‘life cycle management (LCM) change notification’ from the MANO system. By receiving the ‘LCM Change Notification’ received from the MANO system, the VNF (or the EMS, the NE) may receive a report on how its lifecycle is being managed from the MANO system (or an infra system) that manages itself (i.e. the VNF). The VNF should be subscribed to a corresponding MANO system to receive the ‘LCM Change Notification’. For example, the VNF may request the VNFM in the MANO system to subscribe. The VNFM may register the VNF in a subscription list that managed by itself. The VNFM may register the VNF in the subscription list, and then transmit a notification to the VNF when a change occurs in the lifecycle related to the VNF.

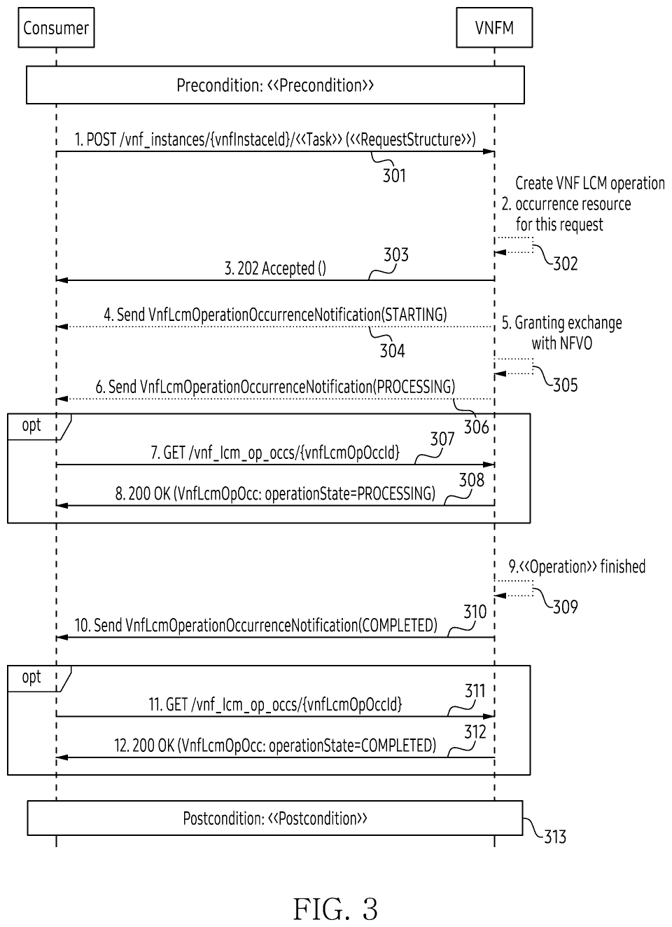

The VNF may be directly connected to the VNFM in the MANO system. Thus, an interface between the VNF and the VNFM may be defined. A specific operation of the VNF and the VNFM for the ‘LCM Change Notification’ will be described in FIG. 3.

FIG. 3 illustrates an example of an operation of a consumer and VNFM for ‘LCM Change notification’ according to an embodiment of the disclosure.

In FIG. 3, the consumer may mean VNF or EM.

Referring to FIG. 3, operation 301 to operation 312 indicate a flow for an entire lifecycle procedure. <<precondition>> and <<postcondition>> of FIG. 3 may be configured as shown in Table 2.

TABLE 2

| Operation | Precondition | Task | RequestStructure | Postcondition |
|---|---|---|---|---|
| Instantiate | VNF instance | instantiate | InstantiateVnfRequest | VNF instance |
| VNF | created and in | | | in |
| | NOT_INSTANTIATED | | | INSTANTIATED |
| | State | | | state. |
| Scale VNF | VNF instance | scale | ScaleVnfRequest | VNF instance |
| | in | | | still in |
| | INSTANTIATED | | | INSTANTIATED |
| | state | | | state and |
| | | | | VNF has been |
| | | | | scaled. |
| Scale VNF | VNF instance | scale_to_level | ScaleVnfToLevel | VNF instance |
| to Level | in | | Request | still in |
| | INSTANTIATED | | | INSTANTIATED |
| | state | | | state and |
| | | | | VNF has been |
| | | | | scaled. |
| Change | VNF instance | change_flavour | ChangeVnfFlavour | VNF instance |
| VNF | in | | Request | still in |
| flavour | INSTANTIATED | | | INSTANTIATED |
| | state | | | state and |
| | | | | VNF |
| | | | | deployment |
| | | | | flavour |
| | | | | changed. |
| Operate | VNF instance | operate | OperateVnfRequest | VNF instance |
| VNF | in | | | still in |
| | INSTANTIATED | | | INSTANTIATED |
| | state | | | state and |
| | | | | VNF |
| | | | | operational |
| | | | | state |
| | | | | changed. |
| Heal VNF | VNF instance | heal | HealVnfRequest | VNF instance |
| | in | | | still in |
| | INSTANTIATED | | | INSTANTIATED |
| | state | | | state. |
| Change | VNF instance | change_ext_conn | ChangeExtVnfConnec- | VNF instance |
| external | in | | tivityRequest | still in |
| VNF | INSTANTIATED | | | INSTANTIATED |
| connectivity | state | | | state and |
| | | | | external |
| | | | | connectivity of |
| | | | | the |
| | | | | VNF is |
| | | | | changed. |
| Terminate | VNF instance | terminate | TerminateVnfRequest | VNF instance |
| VNF | in | | | in |
| | INSTANTIATED | | | NOT_INSTANTIATED |
| | state | | | state. |

In operation 301, the consumer may transmit a POST request to a <<TASK>> resource indicating a lifecycle operation to be executed in a VNF instance. The <<TASK>> resource may include a data structure in a <<RequestStructure>> type in a payload body. <<TASK>> and <<RequestStructure>>, which mean a name of the task resource, may be set differently according to an operation.

In operation 302, the VNFM may instantiate a new “individual VNFLCM operation occurrence” resource for the request.

In operation 303, the VNFM may return a “202 Accepted” response with an HTTP header “Location:” indicating an empty payload body and a new “Individual VNFLCM operation” resource. That is, the “202 Accepted” response may include URI of the resource, which is “ . . . /vnf_1 cm_op_occs/{vnfLcmOpOccId}”.

In operation 304, the VNFM may transmit a lifecycle operation occurrence notification to the consumer to indicate a start of the lifecycle management operation occurrence in a “STARTING” state.

In operation 305, the VNFM and NFVO may exchange approval information.

In operation 306, the VNFM may indicate that the VNF LCM operation occurrence has entered a “PROCESSING” state by sending the VNF lifecycle management operation occurrence notification to the consumer.

In operation 307, the consumer may poll the “individual VNFL LCM operation occurrence” resource to obtain information on an ongoing operation by transmitting a GET request to the resource indicating the VNFL LCM operation occurrence.

In operation 308, in response to the GET request in operation 307, the VNFM may return consumer information on an operation such as an operation state by providing a data structure of a “VnfLcmOpOcc” type to the payload body.

According to an embodiment, operations 307 and 308 may not be performed.

In operation 309, the VNFM may complete <<Operation>.

In operation 310, the VNFM may transmit a VNF life cycle management operation occurrence notification to the consumer to indicate completion of the lifecycle management operation occurrence with a success state “COMPLETED”.

In operation 311, the consumer may transmit a new GET request to the VNFM in the “individual VNFLCM operation occurrence” resource.

In operation 312, the VNFM may return consumer information on an operation result by providing the data structure of the “VnfLcmOpOcc” type to the payload body in response to the GET request according to operation 311.

According to operation 301 to operation 312, the VNFM may send vnfLcmOperationOccurrenceNotification to the consumer (e.g., EMS or NE) in all life cycles. Tis notification may be classified into STARTING, PROCESSING, and COMPLETED according to a progress of the lifecycle.

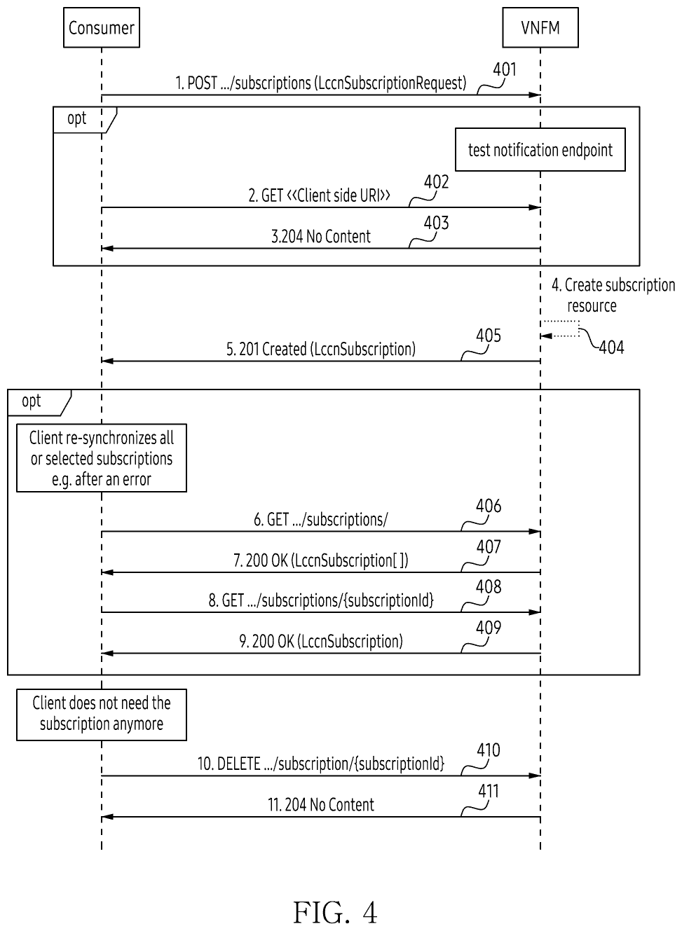

FIG. 4 illustrates an example of an operation of a consumer and VNFM for subscription management according to an embodiment of the disclosure. In FIG. 4, the consumer may mean VNF or EM.

Referring to FIG. 4, operation 401 to operation 411 indicate a flow of a subscription procedure between the consumer and the VNFM.

In operation 401, the consumer may transmit a POST request to a “subscription” resource including a data structure of a “LccnSubscriptionRequest” type in a payload body. The data structure may include a filtering criterion and a callback URI in which the VNFM may later send a notification about an event matching a filter.

In operation 402, in order to test a notification endpoint to which the consumer has subscribed as a portion of the subscription, the VNFM may transmit a GET request to a notification endpoint URI.

In operation 403, the consumer may return a “204 No Content” response to indicate success.

Operation 402 and operation 403 may be performed to test the notification endpoint to which the consumer has subscribed as a portion of the subscription.

In operation 404, the VNFM may create an “Individual Subscription” resource indicating a new subscription and this subscription with respect to a notification related to a VNF lifecycle change.

In operation 405, the VNFM may return a 201 Created response including the data structure of the “LccnSubscription” type indicating the “Individual Subscription” resource just created by the VNFM. The VNFM may provide URI of the newly created resource in a “Location” HTTP header.

In operation 406, the consumer may query information on transmission by transmitting the GET request to a resource indicating the subscription. For example, in order to recover from an error situation, the consumer may query the information on the transmission by sending the GET request to the resource indicating the subscription.

In operation 407, the VNFM may return a “200 OK” response including 0 or more representations among all existing subscriptions generated by an API consumer.

In operation 408, the consumer may read information on a specific subscription by sending the GET request to a resource indicating an individual subscription. For example, in order to recover from an error situation, the consumer may read the information on the specific subscription by sending the GET request to the resource indicating the individual subscription.

In operation 409, the VNFM may return the “200 OK” response including a representation of the individual subscription.

Operation 406 to operation 409 may be performed for a client (e.g., the consumer) to re-synchronize all subscriptions or selected subscriptions.

In operation 410, when the consumer no longer needs a subscription, the subscription may be terminated by transmitting a DELETE request to the resource indicating the individual subscription to remove.

In operation 411, the consumer may identify that the subscription has been successfully terminated by returning the “204 No Content” response.

Operation 410 and operation 411 may be performed in a case that the client (e.g., the consumer) no longer needs the subscription.

According to operation 401 to operation 411, the VNFM may receive a subscription request from the consumer (e.g., EMS, VNF, or NE). The VNFM may update a subscription list managed by itself based on receiving the subscription request.

In the above-described message for the subscription request (e.g., “LccnSubscriptionRequest”) and the message for the subscription response (e.g., “LccnSubscription”), data of Tables 3 and 4 below may be included.

TABLE 3

| Attribute name | Data type | Cardinality | Description |
|---|---|---|---|
| filter | LifecycleChangeNotifi- | 0 . . . 1 | Filter settings for this |
| | cationsFilter | | subscription, to define |
| | | | the subset of all |
| | | | notifications this |
| | | | subscription relates to. |
| | | | A particular notification |
| | | | is sent to the subscriber |
| | | | if the filter matches, or |
| | | | if there is no filter. |
| callbackUri | Uri | 1 | The URI of the |
| | | | endpoint to send the |
| | | | notification to. |
| authentication | SubscriptionAuthen- | 0 . . . 1 | Authentication |
| | tication | | parameters to configure |
| | | | the use of Authorization |
| | | | when sending |
| | | | notifications |
| | | | corresponding to this |
| | | | subscription, as defined |
| | | | in clause 8.4 of ETSI |
| | | | GS NFV-SOL 013 [6]. |
| | | | This attribute shall only |
| | | | be present if the |
| | | | subscriber requires |
| | | | authorization of |
| | | | notifications. |

Referring to Table 3, Table 3 indicates information included in a message sent by the consumer (e.g., EMS, VNF, or NE) to the VNFM. The filter may be a field for designating what the consumer wants to receive from the VNFM. The callbackUri may be URI from which the VNFM may send a notification. The authentication may be information for the VNFM and the EMS to perform authentication.

TABLE 4

| Attribute name | Data type | Cardinality | Description |
|---|---|---|---|
| id | Identifier | 1 | Identifier of this |
| | | | subscription resource. |
| filter | LifecycleChangeNotifi- | 0 . . . 1 | Filter settings for this |
| | cationsFilter | | subscription, to define the |
| | | | subset of all notifications |
| | | | this subscription relates |
| | | | to. A particular |
| | | | notification is sent to the |
| | | | subscriber if the filter |
| | | | matches, or if there is no |
| | | | filter. |
| callbackUri | Uri | 1 | The URI of the endpoint |
| | | | to send the notification to. |
| _links | Structure (inlined) | 1 | Links to resources related |
| | | | to this resource. |
| >self | Link | 1 | URI of this resource. |

Referring to Table 4, Table 4 indicates information included in a message sent to the consumer after the VNFM subscribes to its subscription list. The information may include at least a portion of information (e.g., the information in Table 3) included in the message for the subscription request. Additionally, the information may include information on a subscription id. The VNFM may send “lifecycle change notification” to a subscribed target for management for the lifecycle of the VNF.

Since the VNFM should transmit the same message to one or more targets, the VNFM may transmit “LCM change notification” based on the subscription. For example, the EMS only needs to receive change notification for the EMS when performing the lifecycle such as scaling and upgrade, and the like. On the other hand, NE (e.g., a 5G base station) should be instantiated through a MANO system, which is a virtual resource infrastructure, and then NE (or cell) expansion should be performed through the EMS, which is a base station management system. Therefore, the VNFM should also send the “LCM change notification” to the EMS which will manage the instantiated NE.

For example, the “LCM change notification” may include information (or data) such as Table 5 to Table 7.

TABLE 5

| Attribute name | Data type | Cardinality | Description |
|---|---|---|---|
| id | Identifier | 1 | Identifier of this notification. If a |
| | | | notification is sent multiple times due |
| | | | to multiple subscriptions, the “id” |
| | | | attribute of all these notifications |
| | | | shall have the same value. |
| notificationType | String | 1 | Discriminator for the different |
| | | | notification types. Shall be set to |
| | | | “VnfLcmOperationOccurrenceNotification” |
| | | | for this notification type. |
| subscriptionId | Identifier | 1 | Identifier of the subscription that this |
| | | | notification relates to. |
| timeStamp | DateTime | 1 | Date-time of the generation of the |
| | | | notification. |
| notificationStatus | Enum | 1 | Indicates whether this notification |
| | (inlined) | | reports about the start of a lifecycle |
| | | | operation or the result of a lifecycle |
| | | | operation. Permitted values: |
| | | | START: Informs about the start of |
| | | | the VNF LCM operation occurrence. |
| | | | RESULT: Informs about the final |
| | | | or intermediate result of the VNF |
| | | | LCM operation occurrence. |
| operationState | LcmOpera- | 1 | The state of the VNF LCM operation |
| | tionStateType | | occurrence. |

TABLE 6

| Attribute name | Data type | Cardinality | Description |
|---|---|---|---|
| vnfInstanceId | Identifier | 1 | The identifier of the VNF instance |
| | | | affected. |
| operation | LcmOpera- | 1 | The lifecycle management operation. |
| | tionType | | |
| isAutomaticIn- | Boolean | 1 | Set to true if this VNF LCM |
| vocation | | | operation occurrence has been |
| | | | triggered by an automated procedure |
| | | | inside the VNFM (i.e. |
| | | | Scale Vnf/Scale VnfToLevel |
| | | | triggered by auto-scale, or HealVnf |
| | | | triggered by auto-heal). Set to false |
| | | | otherwise. |
| vnfLcmOpOccId | Identifier | 1 | The identifier of the VNF lifecycle |
| | | | management operation occurrence |
| | | | associated to the notification. |
| affectedVnfcs | Affected | 0 . . . N | Information about VNFC instances |
| | Vnfc | | that were affected during the |
| | | | lifecycle operation. See note. |
| affectedVirtualLinks | Affected | 0 . . . N | Information about VL instances that |
| | VirtualLink | | were affected during the lifecycle |
| | | | operation. See note. |
| affectedVir- | Affected | 0 . . . N | Information about virtualised storage |
| tualStorages | VirtualStorage | | instances that were affected during |
| | | | the lifecycle operation. See note. |

TABLE 7

| Attribute name | Data type | Cardinality | Description |
|---|---|---|---|
| changedInfo | VnfInfoModifications | 0 . . . 1 | Information about the changed VNF |
| | | | instance information, including |
| | | | changed VNF configurable |
| | | | properties. Shall be present if the |
| | | | “notificationStatus” is set to |
| | | | “RESULT”, the “operation” has |
| | | | performed any changes to VNF |
| | | | instance information, including VNF |
| | | | configurable properties. Shall be |
| | | | absent otherwise. |
| changedExtConnectivity | ExtVirtualLinkInfo | 0 . . . N | Information about changed external |
| | | | connectivity, if this notification |
| | | | represents the result of a lifecycle |
| | | | operation occurrence. Shall be present |
| | | | if the “notificationStatus” is set to |
| | | | “RESULT” and the “operation” is set |
| | | | to “CHANGE_EXT_CONN”. Shall |
| | | | be absent otherwise. |
| error | Problem | 0 . . . 1 | Details of the latest error, if one has |
| | | | occurred during executing the LCM |
| | Details | | operation. Shall be present if the |
| | | | “operationState” attribute is |
| | | | “FAILED_TEMP” or “FAILED”, and |
| | | | shall be absent otherwise. |

NOTE:
Shall be present if the “notificationStatus” is set to “RESULT”, the “verbosity” attribute is set to “FULL” and the operation has performed any resource modification. Shall be absent otherwise. This attribute contains information about the cumulative changes to virtualised resources that were performed so far by the VNF LCM operation occurrence and by any of the error handling procedures for that operation occurrence.

Referring to Tables 5 to 7, at least some of the information (or the data) indicated in Tables 5 to 7 may be configured with information included in a VNF Descriptor used when the NE is instantiated. The EMS may receive the information and perform an NE (or cell) expansion operation to be performed based on the information. Therefore, the VNFM and the EMS may have to be mutually subscribed to exchange information of the NE that is managed in common.

According to an embodiment, the EMS may be registered to the subscription list of the VNFM that has instantiated the EMS at an instantiation timing. The EMS may receive a notification of the NE since it is subscribed between the VNFM and the EMS when the VNFM, which has instantiated the EMS to be managed, also instantiated the NE. On the other hand, in a case that a VNFM that instantiated the EMS (i.e., a first VNFM) and a VNFM (i.e., a second VNFM) that instantiated the NE to be managed by the EMS are different, the EMS may not receive information on the NE since they are not subscribed to each other.

According to a difference in an NE management capacity of each EMS and VNFM, a case that the VNFM (i.e., the first VNFM) that instantiated the EMS and the VNFM that instantiated the NE to be managed by the EMS are different may often occur. For example, one VNFM may manage more NEs than one EMS. For example, one EMS may manage more NEs than one VNFM.

According to an embodiment, a management capacity may be set differently according to a vendor manufacturing the EMS and the VNFM. Therefore, in a case that the number of NEs to be managed increases, a difference in the number of the EMS and the VNFM may occur. For example, in case that a total number of NEs to be managed is 800 (or 800), the EMS may require 5 (or 800) and the VNFM may require 8 (or 8). In this case, the VNFM that instantiated the EMS (i.e., the first VNFM) and the VNFM that instantiated the NE to be managed by the EMS (i.e., the second VNFM) may be different.

As in the above-described example, in a case that the EMS and the VNFM are not set to 1:1, there may be a case in which the EMS and the VNFM should perform a subscription procedure with two or more components. In addition, as the number of the EMS and the VNFM increases, the number of cases in which they are not subscribed to each other may increase.

As an example, the first VNFM may instantiate EMS. The EMS may manage NE. The NE managed by the EMS may be instantiated by the second VNFM. The EMS may not receive “LCM change notification” from the second VNFM that instantiated the NE. Therefore, since the EMS does not receive the “LCM change notification” from the second VNFM, it may not be able to recognize the instantiation of the NE. Accordingly, an expansion of the NE (or cell) may not be performed normally. According to an ESTISOL002 specification, it is not described a timing in which the subscription procedure is performed. According to the above-described example, the EMS may not know a timing for performing the subscription procedure with the second VNFM. In other words, in order to perform the subscription procedure, the EMS should know a start timing and an end timing of the second VNFM instantiating the NE and request the subscription to the second VNFM before the NE is instantiated. However, since the EMS does not know the start timing and the end timing of the second VNFM instantiating the NE, it may not be able to request the subscription to the second VNFM before the instantiation. According to an embodiment, in a case of the above-described multi-subscription structure, the subscription of the EMS to the second VNFM may be manually performed. This problem may be difficult to be performed as a network configuration becomes more complex.

As described above, since the EMS does not know the start timing and/or the end timing of the NE instantiation and may not perform the subscription request because there is no authentication information for the VNFM, the EMS and the VNFM should perform the subscription procedure with more than one component. That is, there may be a problem that the subscription procedure is not performed according to a procedure between systems and the subscription procedure should be performed manually by an operator for the EMS and/or VNFM.

In addition, in case that the VNFM that instantiated the EMS and the VNFM that instantiated the NE to be managed by the EMS are different, since the subscription is not performed before, the “LCM change notification” may not be received. In this case, the expansion of the NE (or cell) to be performed later may not be performed normally.

In the following specification, in a case that the EMS and the VNFM need to perform an additional subscription procedure with two or more components, a technical feature for performing the subscription procedure, without an intervention of the operator for the EMS and/or the VNFM, may be described.

According to an embodiment, before an instantiation of a base station (e.g., NE or VNF), the VNFM may call REST API exposed by the EMS. The VNFM may provide the EMS with information necessary for subscription based on calling the REST API. In addition, the VNFM may transmit, to the EMS, information on a timing in which the subscription procedure should be performed based on calling the REST API. According to the above-described embodiment, NE (or cell) expansion to be performed following NE instantiation may be performed through linkage between base station management systems in a complex 5G network, and an operator may not be involved. Hereinafter, a detailed operation of the VNFM, the EMS, and the NE according to the above-described embodiment may be described.

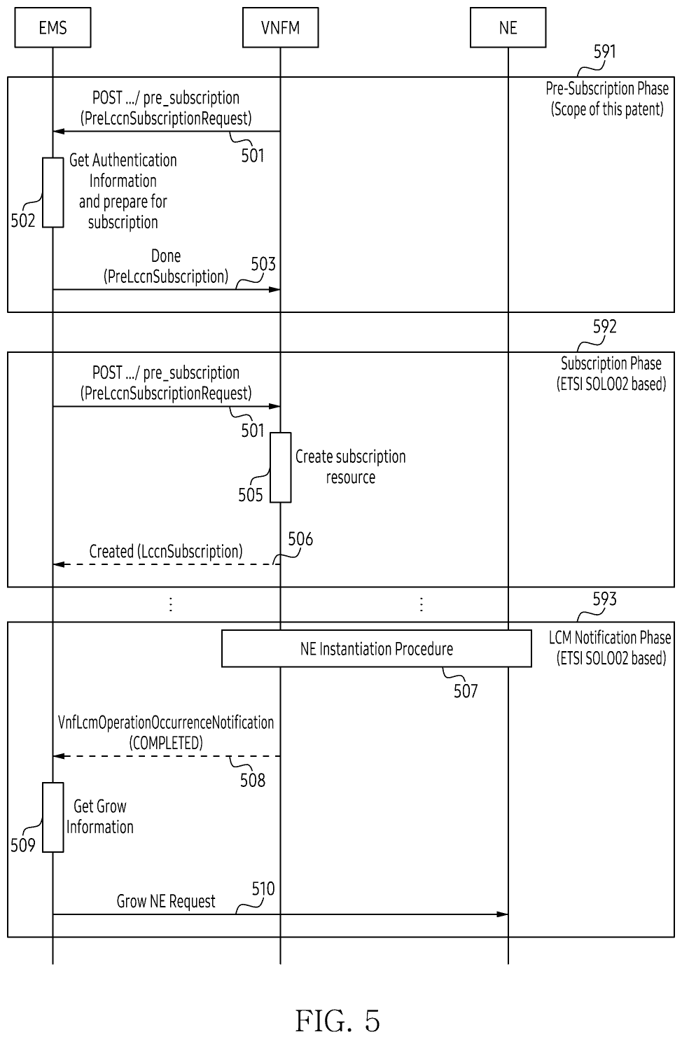

FIG. 5 illustrates an example of an operation of EMS, VNFM, and NE according to an instantiation of the NE according to an embodiment of the disclosure.

Referring to FIG. 5, operation 501 to operation 510 may be divided into a pre-subscription phase 591, a subscription phase 592, and an LCM notification phase 593. Operation 501 to operation 503 may be referred to as the pre-subscription step. Operation 504 to operation 506 may be referred to as the subscription step. Operation 507 to operation 510 may be referred to as the LCM notification step.

In operation 501, the VNFM may call a PreLccnSubscriptionRequest REST API exposed by the EMS. For example, information included in “PreLccnSubscriptionRequest” may be set as illustrated in Table 8.

TABLE 8

| Attribute name | Data type | Cardinality | Description |
|---|---|---|---|
| Authentication | (SubscriptionAu- | 1 | [VNFM → EMS] |
| | thentication | | Authentication parameters to |
| | | | configure the use of Authorization |
| | | | when sending LCM change notifications. |

Referring to Table 8, “PreLccnSubscriptionRequest” may include authentication information. For example, the authentication information may be used to register in a subscription list of the VNFM. The VNFM may transmit the authentication information used by the EMS to request its subscription to the EMS. As an example, the VNFM may transmit the authentication information to the EMS using a request parameter of the REST API.

The authentication information may be divided into “BASIC” and “OAUTH2_CLIENT_CREDENTIALS” according to the VNFM. Information included in the authentication information may be set differently according to each type. The information included in the authentication information may be configured as illustrated in Table 9 according to each type.

TABLE 9

| Attribute name | Data type | Cardinality | Description |
|---|---|---|---|
| authType | Enum | 1 | Defines the type of Authentication/ |
| | | | Authorization to use when sending a |
| | | | notification. Permitted values: |
| | | | BASIC; In every POST request that sends a |
| | | | notification, use HTTP Basic authentication |
| | | | with the client credentials. |
| | | | OAUTH2_CLIENT_CREDENTIALS: In every |
| | | | POST request that sends a notification, use |
| | | | an OAuth 2.0 Bearer token, obtained using |
| | | | the client credentials grant type. |
| paramsBasic | Structure | 0 . . . 1 | Parameters for authentication/authorization |
| | | | using BASIC. Shall be present if authType is |
| | | | 'BASIC”. Shall be absent otherwise. |
| >username | String | 0 . . . 1 | Username to be used in HTTP Basic |
| | | | authentication. |
| >password | String | 0 . . . 1 | Password to be used in HTTP Basic |
| | | | authentication. |
| paramsOauth2Client | Structure | 0 . . . 1 | Parameters for authentication/authorization |
| Credentials | | | using OAUTH2_CLIENT_CREDENTIALS. Shall |
| | | | be present if authType is |
| | | | “OAUTH2_CLIENT_CREDENTIALS”. Shall be |
| | | | absent otherwise |
| >clientId | String | 0 . . . 1 | Client identifier to be used in the access |
| | | | token request of the OAuth 2.0 client |
| | | | credentials grant type. |
| >clientPassword | String | 0 . . . 1 | Client password to be used in the access |
| | | | token request of the OAuth 2.0 client |
| | | | credentials grant type. |
| >tokenEndpoint | Uri | 0 . . . 1 | The token endpoint from which the access |
| | | | token can be obtained. |

Referring to Table 9, in a case that a type of the authentication information is “BASIC”, a username and a password may be provided. For example, in a case that a type of the authentication information is “OAUTH2 CLIENT CREDENTIALS”, clientId, clientPassword, and tokenEndpoint may be provided. According to an embodiment, id and/or password may be fixed.

For example, the VNFM can call the REST API to provide the authentication information that the EMS may subscribe to. For example, the VNFM may call the REST API to notify the EMS of a timing that may subscribe to.

In operation 502, the EMS may parse the authentication information in the REST API request parameter called by the VNFM.

In operation 503, the EMS may respond to the VNFM based on parsing the authentication information. For example, the EMS may send a response message to the VNFM based on parsing the authentication information.

For example, since the purpose of the REST API is to deliver information to the EMS through a request parameter, there may be no information that the EMS will deliver to the VNFM. Information included in the “PreLccnSubscription” may not include any information as illustrated in Table 10.

TABLE 10

| Attribute name | Data type | Cardinality | Description |
|---|---|---|---|
| — | — | — | — |

According to an embodiment, the EMS may transmit information indicating whether “PreLccnSubscriptionRequest” is received to the VNFM. According to an embodiment, information indicating success or failure of transmission of a RESTful message may exist separately from “PreLccnSubscription”.

For example, the VNFM may include a pre-subscription REST API call engine. The VNFM may indicate when the VNFM will call the preLccnSubscriptionRequest REST API to the EMS by using the pre-subscription REST API calling engine. The VNFM may call the preLccnSubscriptionRequest REST API as a pre-work before instantiating the NE that the VNFM manages. Immediately after sending a response to the preLccnSubscriptionRequest REST API, the EMS may perform a subscription request to the VNFM.

In operation 504, the EMS may request the VNFM to subscribe together with the filter and the callbackUri of Table 4 using the authentication information received from the VNFM.

For example, since the VNFM called the pre-subscription REST API before the instantiation of the NE, when the EMS is registered to the subscription list of the VNFM through the subscription request to the VNFM immediately after the call, and then, the EMS may receive an LCM Change notification from the VNFM.

In operation 505, the VNFM may register the EMS in the subscription list. According to an embodiment, in a case that the EMS is already registered to the subscription list, the VNFM may not repeatedly add the EMS to the subscription list.

In operation 506, the VNFM may transmit a response (or a response message) to the EMS to reply to the subscription id and the information requested by the EMS.

In operation 507, the VNFM may perform an NE instantiation process.

In operation 508, the VNFM may transmit “VnfLcmOperationOccurrenceNotification” (COMPLETED) to the EMS after the instantiation of the NE proceeds. “VnfLcmOperationOccurrenceNotification” may include the information in Table 5 to Table 7 described above. A status of a notification may include STARTING″, PROCESSING″, and COMPLETED″. Even when receiving only the “COMPLETED” notification, the EMS may proceed in connection with an NE (or cell) expansion operation, which is the next operation.

In operation 509, the EMS may parse information in VnfLcmOperationOccurrenceNotification (COMPLETED).

In operation 510, the EMS may perform the NE (or cell) expansion operation based on the parsed information.

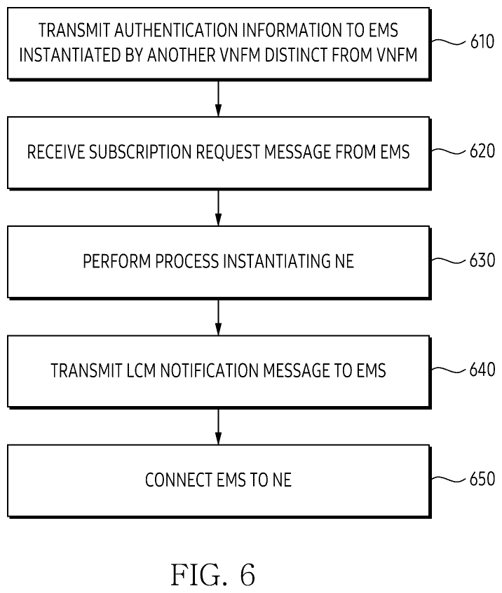

FIG. 6 is a flowchart with respect to an operation of an electronic device for VNFM according to an embodiment of the disclosure.

Referring to FIG. 6, in operation 610, the electronic device (hereinafter referred to as the VNFM) for the VNFM may transmit authentication information to EMS instantiated by another VNFM (or another electronic device for the other VNFM) that is distinct from the VNFM. For example, the authentication information may be used for registration of the VNFM to a subscription list.

For example, EMS may be instantiated by the other VNFM. Since the EMS is instantiated by the other VNFM, the EMS may not be registered to the subscription list of the VNFM. Therefore, the VNFM may not be able to transmit an LCM notification message to the EMS.

For example, since the EMS does not have the authentication information to register to subscription list of the VNFM, it may not register to the subscription list of the VNFM. Therefore, the VNFM may provide the authentication information to register to the subscription list to the EMS so that the EMS may register to the subscription list of the VNFM.

For example, the VNFM may call a representational state transfer application programming interface (REST API) for pre-subscription exposed by the EMS. The VNFM may transmit the authentication information to the EMS by calling the REST API for the pre-subscription exposed by the EMS.

For example, the VNFM may receive a response message from the EMS based on transmitting the authentication information. As an example, the response message may not include payload. According to an embodiment, the response message may include information indicating one of success and failure of reception of a message including the authentication information.

For example, the authentication information may include information on an identifier (ID) and a password for the registration to the subscription list of the VNFM. According to an embodiment, a type of the authentication information may be divided into “BASIC” and “OAUTH2_CLIENT_CREDENTIALS”. Information included in the authentication information may be set differently according to each type. An example of the information included in the authentication information according to the type of the authentication information may be set as illustrated in Table 9 described above.

In operation 620, the VNFM may receive a subscription request message from the EMS. For example, the VNFM may receive the subscription request message including the authentication information from the EMS. For example, the subscription request message may include not only the authentication information, but also filter information on the subscription registration and callback uniform resource identifier (URI) information. For example, an example of the subscription request message may be ‘LccnSubscriptionRequest’ described above.

According to an embodiment, the VNFM may register the EMS to the subscription list based on receiving the subscription request message. The VNFM may transmit, to the EMS, a message including information indicating that the EMS is subscribed to the VNFM, based on registering the EMS to the subscription list.

According to an embodiment, the VNFM may identify that the EMS is registered to the subscription list. The VNFM may receive the subscription request message in a state that the EMS is registered to the subscription list. The VNFM may bypass registration of the EMS to the subscription list based on the subscription request message.

In operation 630, the VNFM may perform a process for instantiating NE. For example, the NE may include a virtual network function (VNF). For example, the VNFM may perform a process for instantiating the NE based on the registration to the subscription list for the EMS. For example, the VNFM may perform a process for instantiating the NE to be connected to the subscribed EMS according to operation 620.

In operation 640, the VNFM may transmit a life cycle management change (LCM) notification message to the EMS. For example, the VNFM may transmit the LCM notification message to the EMS based on the process for instantiating the NE. For example, a status according to a progress of a life cycle may include ‘STARTING’, ‘PROCESSING’, and ‘COMPLETED’. The VNFM may transmit the LCM notification message (‘COMPLETED’) to the EMS based on completion of instantiating the NE. The EMS may identify that the NE is instantiated based on the LCM notification message.

In operation 650, the VNFM may connect the EMS to the NE. For example, the VNFM may control (or cause) the EMS to establish a connection with the NE based on the LCM notification message.

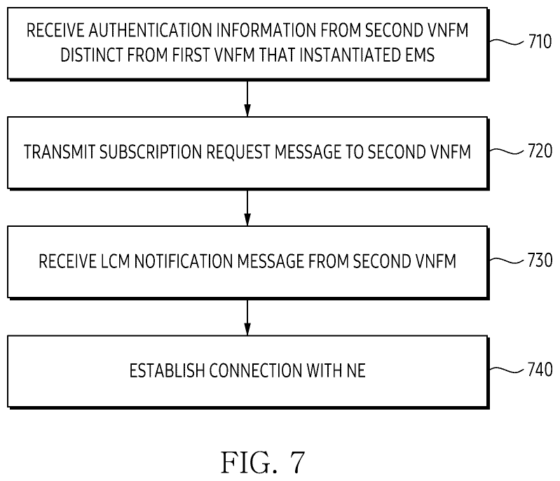

FIG. 7 is a flowchart with respect to an operation of an electronic device for EMS according to an embodiment of the disclosure.

Referring to FIG. 7, in operation 710, the EMS may receive authentication information from a second VNFM distinct from a first VNFM that instantiated the EMS. For example, the authentication information may be used for registration of the second VNFM to a subscription list.

For example, the EMS may be instantiated by the first VNFM. Since the EMS is instantiated by the first VNFM, the EMS may not be registered to the subscription list of the second VNFM. Therefore, the EMS may not transmit an LCM notification message to the second VNFM.

For example, the EMS may not have authentication information for registering to the subscription list of the VNFM. Accordingly, the EMS may receive the authentication information for registering to the subscription list of the VNFM.

For example, the EMS may expose a representational state transfer application programming interface (REST API) for a pre-subscription. The EMS may receive authentication information from the VNFM based on a call of the REST API for the pre-subscription.

For example, the EMS may transmit a response message to the VNFM based on receiving the authentication information. As an example, the response message may not include payload. According to an embodiment, the response message may include information indicating one of success and failure of reception of a message including the authentication information.

For example, the authentication information may include information on an identifier (ID) and a password for the registration to the subscription list of the VNFM. According to an embodiment, a type of the authentication information may be divided into “BASIC” and “OAUTH2_CLIENT_CREDENTIALS”. Information included in the authentication information may be set differently according to each type. An example of the information included in the authentication information according to the type of the authentication information may be set as illustrated in Table 9 described above.

In operation 720, the EMS may transmit a subscription request message to the second VNFM. For example, the EMS may transmit the subscription request message including the authentication information to the second VNFM. The EMS may transmit the subscription request message including authentication information received from the second VNFM to the second VNFM. For example, the subscription request message may include not only the authentication information, but also filter information on the subscription registration and callback uniform resource identifier (URI) information. For example, an example of the subscription request message may be ‘LccnSubscriptionRequest’ described above.

According to an embodiment, the EMS may be registered to the subscription list of the second VNFM based on transmitting the subscription request message to the second VNFM. The EMS may receive, from the second VNFM, a message including information indicating that the EMS is subscribed to the VNFM.

In operation 730, the EMS may receive an LCM notification message from the second VNFM. For example, a process for instantiating NE may be performed in the VNFM. For example, based on the process for instantiating the NE, the LCM notification message may be received in the EMS. For example, a status according to a progress of a life cycle may include ‘STARTING’, ‘PROCESSING’, and ‘COMPLETED’. Based on completion of instantiating the NE, the EMS may receive the LCM notification message (‘COMPLETED’) from the second VNFM. The EMS may identify that the NE is instantiated based on the LCM notification message.

In operation 740, the EMS may establish a connection with the NE. For example, the EMS may establish the connection with the NE based on the LCM notification message. For example, the EMS may establish the connection with the NE based on transmitting a grow NE request message to the NE.

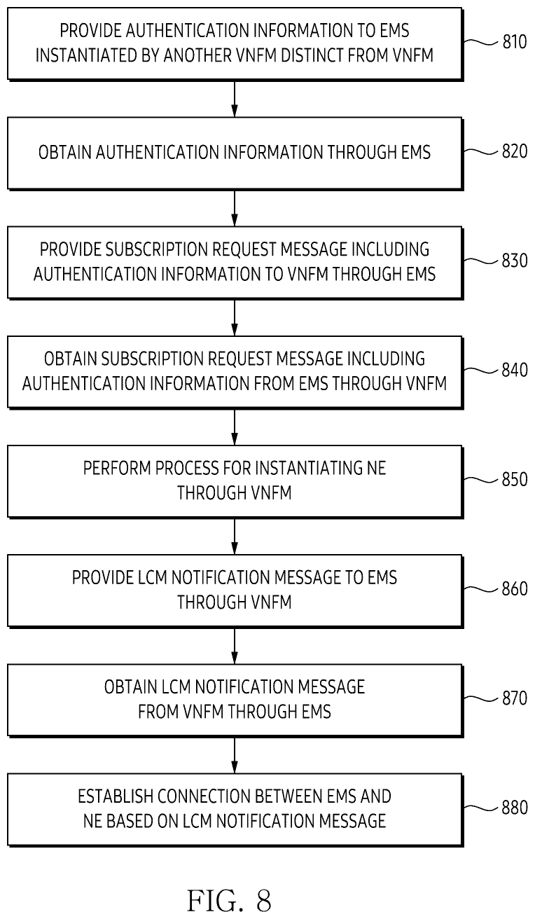

FIG. 8 is a flowchart with respect to an operation of an electronic device for VNFM and EMS according to an embodiment of the disclosure.

Referring to FIG. 8, the electronic device may include VNFM and EMS. For example, the electronic device (or a processor of the electronic device) may perform operation 810 to operation 880 through the VNFM and the EMS.

In operation 810, the electronic device (or the processor of the electronic device) may provide authentication information to EMS instantiated by another VNFM distinct from the VNFM, through the VNFM. For example, the authentication information may be used for registration of the VNFM to a subscription list. Operation 810 may be related to operation 610 of FIG. 6.

In operation 820, the electronic device may obtain the authentication information through the EMS. For example, the electronic device may obtain the authentication information provided from the VNFM through the EMS. Operation 820 may be related to operation 710 of FIG. 7.

In operation 830, the electronic device may provide a subscription request message including the authentication information to the VNFM through the EMS. For example, based on the authentication information, the subscription request message including the authentication information may be provided to the VNBFM through the EMS. Operation 830 may be related to operation 720 of FIG. 7.

In operation 840, the electronic device may obtain the subscription request message including the authentication information from the EMS through the VNFM. Operation 840 may be related to operation 620 of FIG. 6.

In operation 850, the electronic device may perform a process for instantiating NE through the VNFM. For example, the electronic device may perform the process for instantiating the NE through the VNFM based on the registration for the EMS. Operation 850 may be related to operation 630 of FIG. 6.

In operation 860, the electronic device may provide an LCM notification message to the EMS through the VNFM. For example, the electronic device may provide the LCM notification message to the EMS through the VNFM based on the process for instantiating the NE. Operation 860 may be related to operation 640 of FIG. 6.

In operation 870, the electronic device may obtain the LCM notification message from the VNFM through the EMS. Operation 870 may be related to operation 730 of FIG. 7.

In operation 880, the electronic device may establish a connection between the EMS and the NE based on the LCM notification message. The electronic device may control the NE through the EMS by connecting the newly instantiated NE and the EMS. Operation 880 may be related to operation 650 of FIG. 6 and operation 740 of FIG. 7.

Operations according to the above-described embodiment may be implemented in software in a specific device (e.g., a server) or may be implemented as separate hardware devices. A device for performing the above-described operations may include a communication unit, a control unit, and a storage unit.

According to an embodiment, the communication unit provides an interface for performing communication with other devices in a network. That is, the communication unit converts a bit stream transmitted from an entity of a core network to another entity into a physical signal, and converts a physical signal received from another device into a bit stream. That is, the communication unit may transmit and receive signals. Accordingly, the communication unit may be referred to as a modem, a transmit unit, a receive unit, or a transmit/receive unit. At this time, the communication unit enables a core network device to communicate with other devices or a system through a backhaul connection (e.g., wired backhaul or wireless backhaul). The communication unit may include one or more transceivers.

According to an embodiment, the storage unit stores data such as a basic program, an application program, and setting information, and the like, for an operation of the core network device. The storage unit may be configured with a volatile memory, a non-volatile memory, or a combination of the volatile memory and the non-volatile memory. In addition, the storage unit provides the stored data according to a request of the control unit.

According to an embodiment, the control unit controls overall operations of the core network device. For example, the control unit transmits and receives signals through the communication unit. Also, the control unit records and reads data in the storage unit. To this end, the control unit may include at least one processor. According to various embodiments, the control unit may control a device to perform operations according to various embodiments described in the disclosure.

According to an embodiment, in a case that EMS and VNFM have to perform a subscription procedure with two or more components, the subscription procedure may be performed without intervention of an operator. A REST API exposed (or provided) by the EMS may be called by the VNFM prior to an instantiation of NE (e.g., VNF). The VNFM may provide the EMS with authentication information necessary for subscription. Based on the EMS receiving (or obtaining) the authentication information from the VNFM, the EMS may identify a timing when the subscription procedure should be performed. Accordingly, the intervention of the operator in a complex network (e.g., a 5G network) may be minimized. In addition, based on linkage between base station management systems, NE (or cell) expansion to be performed following NE instantiation may be performed normally.

According to an embodiment, a method performed by an electronic device for a virtualised network function manager (VNFM) may comprise transmitting authentication information to an element management system (EMS) instantiated by another VNFM distinct from the VNFM. The authentication information may be used for a registration to a subscription list of the VNFM. The method may comprise receiving, from the EMS, a subscription request message including the authentication information. The method may comprise performing, based on the registration for the EMS, a process for an instantiation of a network element (NE). The method may comprise, based on the process for the instantiation of the NE, transmitting, to the EMS, a lifecycle management change (LCM) notification message. The method may comprise, based on the LCM notification message, connecting the NE to the EMS.

According to an embodiment, the method may comprise receiving, based on transmitting the authentication information, a response message from the EMS. The response message may not include payload.

According to an embodiment, the authentication information may comprise an identifier (ID) and information on a password for the registration to the subscription list of the VNFM.

According to an embodiment, the method may comprise, based on the subscription request message including the authentication information, registering the EMS to the subscription list. The method may comprise, based on registering the EMS to the subscription list, transmitting at least one of a subscription identifier (ID) allocated to the EMS and information indicating that EMS is registered to the subscription list.

According to an embodiment, the method may comprise, based on the subscription request message including the authentication information, identifying that the EMS is registered to the subscription list. The method may comprise bypassing registering the EMS to the subscription list.

According to an embodiment, the subscription request message may include filter information on the subscription registration and callback uniform resource identifier (URI).

According to an embodiment, the method may comprise, based on completion of instantiation of the NE, transmitting, to the EMS, the LCM notification message indicating that the instantiation of the NE is completed.

According to an embodiment, the NE may comprise a virtualized network function (or a virtualized network function manager) (VNF).

According to an embodiment, the method may comprise requesting a representational state transfer application programming interface (REST API) for a pre-subscription exposed by the EMS.

According to an embodiment, a method performed by an electronic device for an element management system (EMS) may comprise receiving authentication information from a second virtualised network function manager (VNFM) distinct from a first VNFM. The authentication information may be used for a registration to a subscription list of the second VNFM. The method may comprise, based on the authentication information, transmitting, to the second VNFM, a subscription request message including the authentication information. The method may comprise, based on a process for an instantiation of a network element (NE), receiving, from the second VNFM a lifecycle management change (LCM) notification message. The method may comprise, based on the LCM notification message, establishing a connection to the NE.

According to an embodiment, the method may comprise, based on receiving the authentication information, transmitting a response message to the second VMFM. The response message may not include payload.

According to an embodiment, the authentication information may comprise an identifier (ID) and information on a password for the registration to the subscription list of the VNFM.

According to an embodiment, the method may comprise, based on the EMS being registered to the subscription list, receiving at least one of a subscription identifier (ID) allocated to the EMS and information indicating that EMS is registered to the subscription list.

According to an embodiment, the subscription request message may include filter information on the subscription registration and callback uniform resource identifier (URI).

According to an embodiment, the method may comprise, based on completion of instantiation of the NE, transmitting, to the EMS, the LCM notification message indicating that the instantiation of the NE is completed.

According to an embodiment, the NE may comprise a virtualised network function (VNF).

According to an embodiment, the method may comprise requesting a representational state transfer application programming interface (REST API) for a pre-subscription exposed by the EMS.

According to an embodiment, the method may comprise, based on the authentication information, identifying that the EMS may be registered in the subscription list of the second VNFM. The method may comprise, based on identifying that the EMS is capable of being registered in the subscription list of the second VNFM, transmitting, to the second VNFM, the subscription request message including the authentication information.

According to an embodiment, an electronic device for a virtualised network function manager (or a virtualized network function manager) (VNFM) may comprise memory, a transceiver, and at least one processor operatively coupled with the memory and the transceiver. The at least one processor may be configured to transmit authentication information to an element management system (EMS) instantiated by another VNFM distinct from the VNFM. The authentication information may be used for a registration to a subscription list of the VNFM. The at least one processor may be configured to receive, from the EMS, a subscription request message including the authentication information. The at least one processor may be configured to perform, based on the registration for the EMS, a process for an instantiation of a network element (NE). The at least one processor may be configured to, based on the process for the instantiation of the NE, transmit, to the EMS, a lifecycle management change (LCM) notification message. The at least one processor may be configured to, based on the LCM notification message, connect the NE to the EMS.

According to an embodiment, an electronic device may comprise memory, a transceiver, and at least one processor operatively coupled with the memory and the transceiver. The at least one processor may be configured to provide, through a virtualised network function manager (VNFM), authentication information to an element management system (EMS) instantiated by another VNFM distinct from the VNFM. The authentication information may be used for a registration to a subscription list of the VNFM. The at least one processor may be configured to obtain the authentication information through the EMS. The at least one processor may be configured to, based on the authentication information, provide, to the VNFM, a subscription request message including the authentication information through the EMS. The at least one processor may be configured to obtain, from the EMS, the subscription request message including the authentication information, through the VNFM. The at least one processor may be configured to, based on the registration for the EMS, perform a process for an instantiation of a network element (NE), through the VNFM. The at least one processor may be configured to, based on the process for the instantiation of the NE, provide, to the EMS, a lifecycle management change (LCM) notification message, through the VNFM. The at least one processor may be configured to obtain, from the VNFM, the LCM notification message through the EMS. The at least one processor may be configured to, based on the LCM notification message, establish a connection between the EMS and the NE.

According to an embodiment, an electronic device for a virtualised (or virtualized) network function manager (VNFM) may comprise memory storing instructions, a transceiver, and a processor. The instructions, when executed by the processor, may cause the electronic device to transmit authentication information to an element management system (EMS) instantiated by another VNFM distinct from the VNFM. The authentication information may be used for a registration to a subscription list of the VNFM. The instructions, when executed by the processor, may cause the electronic device to receive, from the EMS, a subscription request message including the authentication information. The instructions, when executed by the processor, may cause the electronic device to perform, based on the registration for the EMS, a process for an instantiation of a network element (NE). The instructions, when executed by the processor, may cause the electronic device to, based on the process for the instantiation of the NE, transmit, to the EMS, a lifecycle management change (LCM) notification message. The instructions, when executed by the processor, may cause the electronic device to, based on the LCM notification message, connect the NE to the EMS.

According to an embodiment, an electronic device may comprise memory, a transceiver, and a processor. The instructions, when executed by the processor, may cause the electronic device to provide, through a virtualised network function manager (VNFM), authentication information to an element management system (EMS) instantiated by another VNFM distinct from the VNFM. The authentication information may be used for a registration to a subscription list of the VNFM. The instructions, when executed by the processor, may cause the electronic device to obtain the authentication information through the EMS. The instructions, when executed by the processor, may cause the electronic device to, based on the authentication information, provide, to the VNFM, a subscription request message including the authentication information through the EMS. The instructions, when executed by the processor, may cause the electronic device to obtain, from the EMS, the subscription request message including the authentication information, through the VNFM. The instructions, when executed by the processor, may cause the electronic device to, based on the registration for the EMS, perform a process for an instantiation of a network element (NE), through the VNFM. The instructions, when executed by the processor, may cause the electronic device to, based on the process for the instantiation of the NE, provide, to the EMS, a lifecycle management change (LCM) notification message, through the VNFM. The instructions, when executed by the processor, may cause the electronic device to obtain, from the VNFM, the LCM notification message through the EMS. The instructions, when executed by the processor, may cause the electronic device to, based on the LCM notification message, establish a connection between the EMS and the NE.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for a virtualised network function manager (VNFM), the method comprising:
transmitting authentication information to an element management system (EMS) instantiated by another VNFM distinct from the VNFM, wherein the authentication information is used for a registration to a subscription list of the VNFM;
receiving, from the EMS, a subscription request message including the authentication information;
performing, based on the registration for the EMS, a process for an instantiation of a network element (NE);
based on the process for the instantiation of the NE, transmitting, to the EMS, a lifecycle management change (LCM) notification message; and
based on the LCM notification message, connecting the NE to the EMS.

2. The method of claim 1,
wherein the method comprises receiving, based on transmitting the authentication information, a response message from the EMS, and
wherein the response message does not include payload.

3. The method of claim 1, wherein the authentication information comprises an identifier (ID) and information on a password for the registration to the subscription list of the VNFM.

4. The method of claim 1, wherein the method further comprises:
based on the subscription request message including the authentication information, registering the EMS to the subscription list; and
based on registering the EMS to the subscription list, transmitting at least one of a subscription identifier (ID) allocated to the EMS and information indicating that EMS is registered to the subscription list.

5. The method of claim 1, wherein the method further comprises:
based on the subscription request message including the authentication information, identifying that the EMS is registered to the subscription list; and
bypassing registering the EMS to the subscription list.

6. The method of claim 1, wherein the subscription request message further includes filter information on the subscription registration and callback uniform resource identifier (URI).

7. The method of claim 1, wherein the method further comprises:
based on completion of instantiation of the NE, transmitting, to the EMS, the LCM notification message indicating that the instantiation of the NE is completed.

8. The method of claim 1, wherein the NE comprises a virtualised network function (VNF).

9. The method of claim 1, wherein the method further comprises requesting a representational state transfer application programming interface (REST API) for a pre-subscription exposed by the EMS.

10. A method performed by an electronic device for an element management system (EMS), the method comprising:
receiving authentication information from a second virtualised network function manager (VNFM) distinct from a first VNFM, wherein the authentication information is used for a registration to a subscription list of the second VNFM;
based on the authentication information, transmitting, to the second VNFM, a subscription request message including the authentication information;
based on a process for an instantiation of a network element (NE), receiving, from the second VNFM a lifecycle management change (LCM) notification message; and
based on the LCM notification message, establishing a connection to the NE.

11. The method of claim 10,
wherein the method comprises, based on receiving the authentication information, transmitting a response message to the second VNFM, and
wherein the response message does not include payload.

12. The method of claim 10, wherein the authentication information comprises an identifier (ID) and information on a password for the registration to the subscription list of the VNFM.

13. The method of claim 10, wherein the method further comprises, based on the EMS being registered to the subscription list, receiving at least one of a subscription identifier (ID) allocated to the EMS and information indicating that EMS is registered to the subscription list.

14. An electronic device for a virtualised network function manager (VNFM), the electronic device comprising:
memory, comprising one or more storage media, storing instructions;
a transceiver; and
one or more processors communicatively coupled to the memory and the transceiver,
wherein the instructions, when executed by the one or more processors individually or collectively, cause the electronic device to:
transmit authentication information to an element management system (EMS) instantiated by another VNFM distinct from the VNFM, wherein the authentication information is used for a registration to a subscription list of the VNFM,
receive, from the EMS, a subscription request message including the authentication information,
perform, based on the registration for the EMS, a process for an instantiation of a network element (NE),
based on the process for the instantiation of the NE, transmit, to the EMS, a lifecycle management change (LCM) notification message, and
based on the LCM notification message, connect the NE to the EMS.

15. An electronic device comprising:
memory, comprising one or more storage media, storing instructions;
a transceiver; and
one or more processors communicatively coupled to the memory and the transceiver,
wherein the instructions, when executed by the one or more processors individually or collectively, cause the electronic device to:
provide, through a virtualised network function manager (VNFM), authentication information to an element management system (EMS) instantiated by another VNFM distinct from the VNFM, wherein the authentication information is used for a registration to a subscription list of the VNFM,
obtain the authentication information through the EMS,
based on the authentication information, provide, to the VNFM, a subscription request message including the authentication information through the EMS,
obtain, from the EMS, the subscription request message including the authentication information, through the VNFM,
based on the registration for the EMS, perform a process for an instantiation of a network element (NE), through the VNFM,
based on the process for the instantiation of the NE, provide, to the EMS, a lifecycle management change (LCM) notification message, through the VNFM,
obtain, from the VNFM, the LCM notification message through the EMS, and
based on the LCM notification message, establish a connection between the EMS and the NE.

16. The electronic device of claim 15,
wherein the instructions, when executed by the one or more processors individually or collectively, further cause the electronic device to, based on receiving the authentication information, transmitting a response message to a second VNFM, and
wherein the response message does not include payload.

17. The electronic device of claim 15, wherein the authentication information comprises an identifier (ID) and information on a password for the registration to the subscription list of the VNFM.

18. The electronic device of claim 15, wherein the instructions, when executed by the one or more processors individually or collectively, further cause the electronic device to, based on the EMS being registered to the subscription list, receiving at least one of a subscription identifier (ID) allocated to the EMS and information indicating that EMS is registered to the subscription list.

19. One or more non-transitory computer-readable storage media storing one or more computer programs including computer-executable instructions that, when executed by one or more processors of an electronic device individually or collectively, cause the electronic device to perform operations, the operations comprising:
transmitting authentication information to an element management system (EMS) instantiated by another VNFM distinct from the VNFM, wherein the authentication information is used for a registration to a subscription list of the VNFM;
receiving, from the EMS, a subscription request message including the authentication information;
performing, based on the registration for the EMS, a process for an instantiation of a network element (NE);
based on the process for the instantiation of the NE, transmitting, to the EMS, a lifecycle management change (LCM) notification message; and
based on the LCM notification message, connecting the NE to the EMS.

20. The one or more non-transitory computer-readable storage media of claim 19, the operations further comprising:
receiving, based on transmitting the authentication information, a response message from the EMS,
wherein the response message does not include payload.
